(19) United States
(12) Patent Application Publication
(10) Pub. No.: US 2006/0023703 A1
(43) Pub. Date: Feb. 2, 2006

(54) Image processing apparatus

(75) Inventor: Takaaki Hosoda, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Oki Data Corporation

(21) Appl. No.: 11/190,519

(22) Filed: Jul. 27, 2005

(30) Foreign Application Priority Data
Jul. 29, 2004 (JP) 2004-221507

(51) Int. Cl. H04L 12/66; H04L 12/28; H04L 12/56

(52) U.S. Cl. 370/354; 370/419

(57) ABSTRACT

An image processing apparatus includes a wired and wireless distinguishing unit for distinguishing frames as to whether the frames are transmitted or received through wired communications or through wireless communications, a wired communication frame editing dividing unit for editing or dividing the frame on a basis of a wired communication corresponding protocol where the frame is transmitted or received through the wired communication according to the distinguished result obtained at the wired and wireless distinguishing unit, and a wireless communication frame editing dividing unit for editing or dividing the frame on a basis of a wireless communication corresponding protocol where the frame is transmitted or received through the wireless communication according to the distinguished result obtained at the wired and wireless distinguishing unit, thereby reducing the total costs of the apparatus.

### BACKGROUND OF THE INVENTION

1. Field of the Invention

This invention relates to an image processing apparatus connectable to networks through a wireless system.

2. Description of Related Art

Recent image processing apparatuses are connected to networks and frequently used for communications with other terminal devices of the networks. Such image processing apparatuses are therefore required to be adapted to plural network protocols. Because connected to the networks via a prescribed NIC (network interface card), conventional image processing apparatuses have to change the NIC at each time when connecting to other networks employing different protocols. Consequently, the total costs of the image processing apparatus including the NICs that the apparatus possesses become expensive.

To make this inconvenience better to some extent, a technology has been disclosed in Japanese Unexamined Patent Publication No. Heisei 6-85871, in which the NIC is divided into a software module and a hardware module and in which at least the hardware module can be commonly used where the apparatus is connected to other networks having the different protocols. This technology renders lower to some extent the total costs of the image processing apparatus adaptive to plural network protocols.

According to recent wider use of wireless LAN, image processing apparatuses are strongly desired as connectable to the networks through wireless system. In such a case, with the above technology, the hardware modules are largely different from one another and cannot be used commonly between situations of wired connection and wireless connection even where the same network is to be connected. An adaptor device specialized for wireless communication, e.g., wireless LAN adaptor or the like, therefore has to be used, resulting in one factor for a higher total costs of the image processing apparatus.

The problem to be solved herein resides at a situation that such an image processing apparatus of the prior art causes increased total costs because the apparatus needs a special adaptor for wireless communication, e.g., wireless LAN adaptor, to connect with the networks through wireless communications even where the image processing apparatus is connected with the same network (including a situation connecting directly to other terminal apparatuses).

It is an object of the invention to provide an image processing apparatus easily connectable to prescribed networks and further directly to other terminal apparatuses either through wired communications or through wireless communications without using any adaptor apparatus for wireless communications.

### SUMMARY OF THE INVENTION

According to the invention, an image processing apparatus includes an interface function connecting itself to one or more networks (including direct connections to other terminal apparatuses) divided into a hardware section and a controlling means for controlling the hardware portion. The hardware portion includes both of a wired communication portion and a wireless communication portion. The controlling means includes a wired and wireless distinguishing unit for distinguishing as to whether the frame is received or to be transmitted through the wired communication or through the wireless communication, a wired communication frame dividing or editing unit for processing said frame on a basis of a wired communication corresponding protocol in a case where the frame is received or to be transmitted through the wired communication according to the distinguished result, and a wireless communication frame dividing or editing unit for processing the frame on a basis of a wireless communication corresponding protocol in a case where said frame is received or transmitted through the wireless communication according to the distinguished result. The controlling means may further includes a wired communication frame transmitting and receiving unit for transmitting and receiving said frame through the wired communication, and a wireless communication frame transmitting and receiving unit for transmitting and receiving said frame through the wireless communication, which are serving as a self controlling means.

### BRIEF DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein;

FIG. 1 is a structural block diagram showing an image processing apparatus according to a first embodiment of the invention;

FIG. 2 is a frame diagram showing a frame structure in the first embodiment, in which portion (a) shows a wireless frame whereas portion (b) shows a wired frame;

FIG. 3 is a flowchart for transmission operation in the first embodiment;

FIG. 4 is a flowchart for reception operation in the first embodiment;

FIG. 5 is a structural block diagram showing an image processing apparatus according to a second embodiment of the invention;

FIG. 6 is an illustration for depicting functions of a wireless communication frame transmitting and receiving unit of the second embodiment;

FIG. 7 is a structural block diagram showing an image processing apparatus according to a third embodiment of the invention;

FIG. 8 is a table for nation based parameters;

FIG. 9 is an operation flowchart for a nation based parameter setting unit;

FIG. 10 is a structural block diagram showing an image processing apparatus according to a fourth embodiment of the invention;

FIG. 11 is a table for nation and area based parameters;

FIG. 12 is an operation flowchart for nation and area based parameter setting unit;

FIG. 13 is a structural block diagram showing an image processing apparatus according to a fifth embodiment of the invention;

FIG. 14 is a table for particular information;

FIG. 15 is a structural block diagram showing an image processing apparatus according to a sixth embodiment of the invention; and

FIG. 16 is a table for address information.

### DETAILED DESCRIPTION OF PREFERRED EMBODIMENTS OF THE INVENTION

In embodiments of the invention, an image processing apparatus includes an interface function connecting to networks, including situations connecting directly to other terminal apparatuses. This interface functionality is divided into a hardware section and a controlling means for controlling the hardware section, and the hardware section is structured in a minimum scale while the controlling means for controlling the hardware section is constituted of the CPU (central processing unit) provided inside the image processing apparatus without depending on any NIC (network interface card) or like. In the following embodiments, image processing apparatuses are exemplified as printers, but image processing apparatuses according to the invention can be any other image processing apparatuses such as, e.g., facsimile machines, photocopiers, image readers or scanners, cameras, video devices, personal computers, personal digital assistances, and cellular phones.

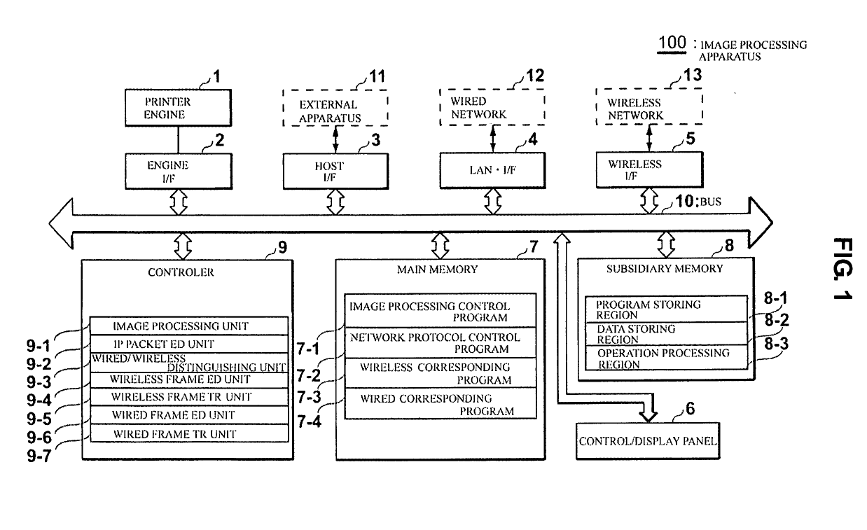

FIG. 1 is a structural block diagram showing an image processing apparatus according to the first embodiment. As shown in FIG. 1, an image processing apparatus 100 according to the first embodiment includes a printer engine 1, an engine I/F (interface section) 2, a host I/F (interface section) 3, a LAN I/F (interface section) 4, a wireless I/F (interface section) 5, a control and display panel 6, a main memory 7, a subsidiary memory 8, a controller 9, and a bus 10.

The printer engine 1 is an image forming section for printing some printing data on a printing medium and outputting the medium based on control from the controller 9. The engine I/F 2 is an interface section connecting the printer engine 1 to the bus 10 based on control from the controller 9. The host I/F 3 is an interface section connecting to an external apparatus 11 and a bus 10 based on control from the controller 9.

The LAN I/F 4 is an interface section connecting the image processing apparatus 100 to a wired communication network 12, or simply a wired network 12, for transmitting and receiving frames, and particularly, in this embodiment, only the hardware section of the interface section is shown and is no more than the physical layer of the OSI (Open System Interconnection) reference model. This hardware section is controlled by the controller 9, or CPU, as different from prior art using a NIC (network interface card).

The wireless I/F 5 is an interface section connecting to a wireless communication network 13, or simply a wireless network 13, for transmitting and receiving frames, and particularly, in this embodiment, only the hardware section of the interface section is shown. This hardware section is controlled by the controller 9, or CPU, as different from prior art using a wireless LAN adaptor.

The control and display panel 6 is a portion serving as a man to machine interface between the image processing apparatus 100 and the operator, and has an information inputting mechanism such as a keyboard and switches, and an information displaying function such as a display device or monitor.

The main memory 7 in advance stores a control program and controlling data necessary for controlling the image processing apparatus 100 by the controller 9. In this embodiment, stored previously are an image processing control program 7-1, a network protocol control program 7-2, a wireless corresponding program 7-3, and a wired corresponding program 7-4.

The image processing control program 7-1 includes all of control programs necessary for converting image data contained in received frames into printing data, and all of control programs necessary for converting information inputted by the operator using the control and display panel 6 into image data. The network protocol control program 7-2 is a control program for matching the protocol of the network designed to be connected with the image processing apparatus 100. The wireless corresponding program 7-3 is a program controlling a processing to be added partly to the network protocol program 7-2 in a case where the image processing apparatus 100 is connected to a prescribed network through the wireless communication. The wired corresponding program 7-4 is a program controlling a processing to be added partly to the network protocol program 7-2 in a case where the image processing apparatus 100 is connected to a prescribed network directly or through the wired communication.

The subsidiary memory 8 is a memory necessary for reading and temporarily storing the control programs and the control data necessary for controlling the image processing apparatus 100 by the controller 9 out of the main memory 7, and executing the control programs. The subsidiary memory 8 includes inside a program storing region 8-1 for temporally storing the necessary control programs, a data storing region 8-2 for temporally storing the necessary control data, and an operation processing region 8-3 necessary for operation processing.

The controller 9 is a CPU for controlling the entire sections of the image processing apparatus 100. In this embodiment, the controller 9 constitutes, by executing the control programs temporarily stored in the subsidiary memory 8, an image processing unit 9-1, an IP packet editing dividing unit (IP packet ED unit) 9-2, a wired and wireless distinguishing unit 9-3, a wireless frame editing dividing unit (wireless frame ED unit) 9-4, a wireless frame transmitting receiving unit (wireless frame TR unit) 9-5, a wired frame editing dividing unit (wired frame ED unit) 9-6, and a wired frame transmitting receiving unit (wired frame TR unit) 9-7.

The image processing unit 9-1 is a controlling unit for converting the image data contained in the received frames into the printing data and converting the image information inputted by the operator using the control and display panel 6 into the image data.

The IP packet editing dividing unit 9-2 is a control unit for dividing the received frames based on a protocol matching to the network and editing the IP packets, and for dividing the IP packets to be transmitted based on a protocol matching to the network and constituting the frames to be transmitted.

The wired and wireless distinguishing unit 9-3 is a control unit for distinguishing as to whether the received frame is a frame received through the wired communication or a frame received through the wireless communication. The unit 9-3 normally makes distinction based on a header added to the received frame. More specifically, the distinction as that the received frame is the wireless communication frame is made by detecting a PLCP header particular to wireless communication LAN and a MAC header of the IEEE 802.11. The unit 9-3 also serves as a unit for distinguishing as to whether a frame to be transmitted is a frame to be transmitted through the wired communication or a frame to be transmitted through the wireless communication. This distinction is made normally based on the information inputted by the operator using the control and display panel 6 or based on preset information by the operator regarding I/F (wired LAN or wireless LAN) having the priority.

The wireless frame editing dividing unit 9-4 is a control unit for allowing, according to the distinguishing result of the wired and wireless distinguishing unit 9-3, IP packet edition by the IP packet editing dividing unit 9-2 upon dividing the frame based on the wireless corresponding protocol in a case where the received frame is a frame received through the wireless communication, and for constituting a frame or frames based on the wireless corresponding protocol in a case where the frame to be transmitted is transmitted through the wireless communication.

The wireless frame transmitting receiving unit 9-5 is a control unit for transmitting and receiving frames upon controlling the wireless I/F 5.

The wired frame editing dividing unit 9-6 is a control unit for allowing, according to the distinguishing result of the wired and wireless distinguishing unit 9-3, IP packet edition by the IP packet editing dividing unit 9-2 upon dividing the frame based on the wired corresponding protocol in a case where the received frame is a frame received through the wired communication, and for constituting a frame or frames based on the wired corresponding protocol in a case where the frame to be transmitted is transmitted through the wired communication.

The wired frame transmitting receiving unit 9-7 is a control unit for transmitting and receiving frames upon controlling the LAN I/F 4.

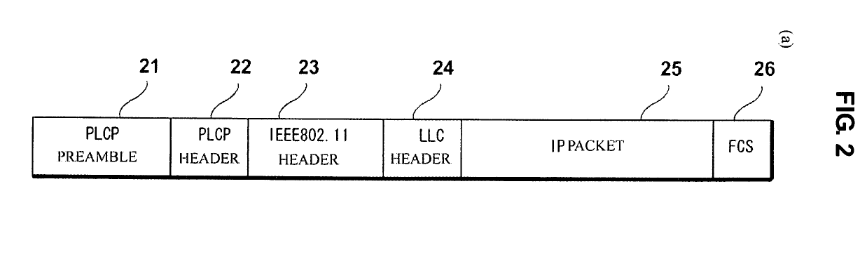

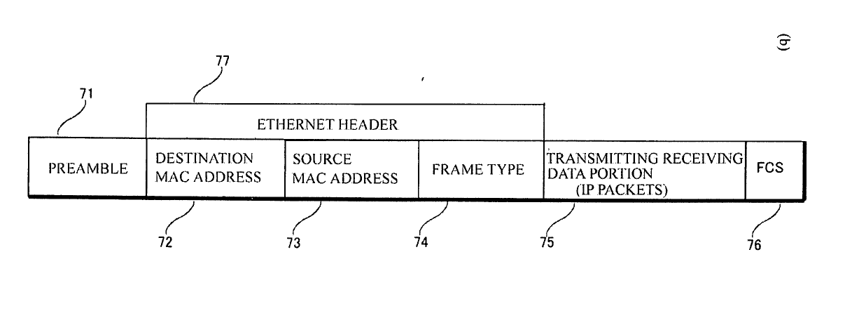

In operation of the image processing apparatus 100 according to the first embodiment, FIG. 2 is a diagram showing the frame structure of the first embodiment; this diagram shows a structure of a wireless frame necessary for describing the operation of the image processing apparatus according to the first embodiment.

As shown in portion (a) of FIG. 2, the wireless frame, as an example, used in this embodiment is formed of a PLCP preamble 21, a PLCP header 22, an IEEE 802.11 header 23, an LLC header 24, an IP packet 25, and an FSC 26.

The term “PLCP” is an abbreviation of Physical Layer Convergence Protocol, and is a protocol defining the physical layer of the OSI reference model about transmission rate and MAC frame in the rule of IEEE 802.11.

The PLCP preamble 21 is a signal for establishing synchrony. The PLCP header 22 is a header indicating compliance to the PLCP. The IEEE 802.11 header 23 is a header indicating compliance to a protocol of the wireless LAN defined at the working group of the IEEE 802 committee. The LLC header 24 indicates a protocol of a network layer to which the received packets are matching. The IP packet 25 is (image) data to be transmitted. The FSC 26 is a check sequence.

In FIG. 2, portion (b) shows a wired frame used for operation of the image processing apparatus according to this embodiment. In this embodiment, the Ethernet frame is used as the wired frame.

As shown in FIG. 2, the Ethernet frame is formed of a preamble 71, a destination MAC address 72, a source MAC address 73, a frame type 74, a transmitting receiving data portion (IP packets) 75, and an FCS 76. The destination MAC address 72, the source MAC address 73, and the frame type 74, among those portions, constitute an Ethernet frame 77.

The preamble 71 is a signal for establishing synchrony. The destination MAC address 72 and the source MAC address 73 are used as addresses for districting the addresses of the addressee and transmitter stations. The frame type 74 is an identifier showing the protocol of the data portion, and in this embodiment, the digits thereof are “0x0800” because the IP packets are used for data.

The data portion 75 is data actually transmitted and received, and in this embodiment, is IP packets according to the IP protocol. The FCS 76 is a frame checking sequence for error detection.

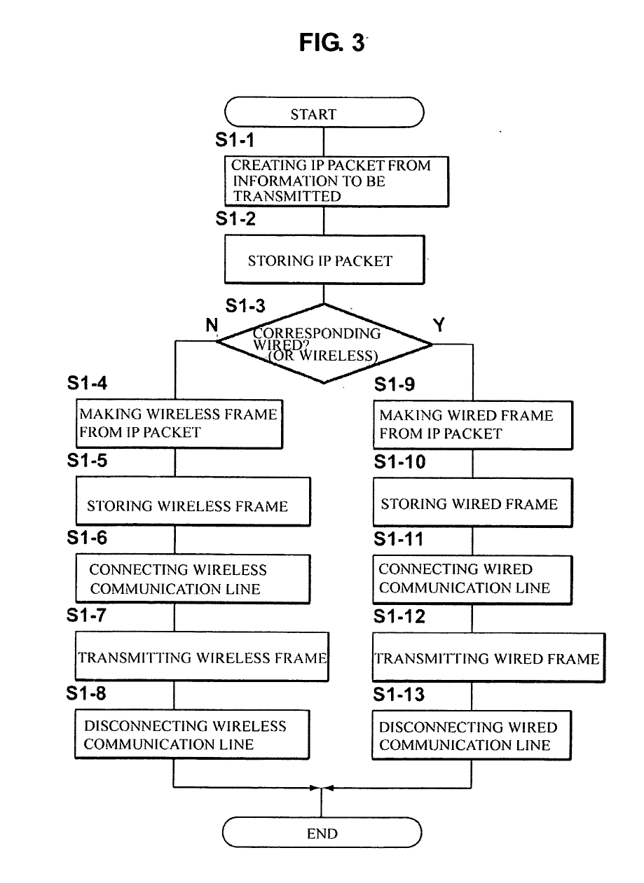

FIG. 3 is a flowchart of transmission operation of the first embodiment. FIG. 3 shows an example of the transmission operation of the image processing apparatus according to the first embodiment. The transmission operation of the image processing apparatus according to the first embodiment is described according to the order of steps from step S1-1 to step S1-13 in FIG. 3.

At step S1-1, the image processing unit 9-1 (see, FIG. 1) converts the image information inputted by the operator using the control and display panel 6 (see, FIG. 1) into image data. Alternatively, the image processing unit 9-1 converts into the transmission data the information in a case that a designated condition is satisfied where the operator previously designates the information to be transmitted (e.g., alarm information). The IP packet editing dividing unit 9-2, shown in FIG. 1, creates an IP packet from the image data or the transmission data based on a protocol matching to the transmitting network to which the image data is transmitted.

At step S1-2, the IP packet is stored in the data storing region 8-2 (see, FIG. 1) in the subsidiary memory 8 (see, FIG. 1).

The wired and wireless distinguishing unit 9-3 determines at step S1-3 as to whether the IP packet is to be transmitted through the wired communication or through the wireless communication. This distinction is made normally based on information inputted by the operator using the control and display panel 6. If the resulted distinction is for transmission through the wireless communication, the operation goes to step S1-4, while if the resulted distinction is for transmission through the wired communication, the operation goes to step S1-9. First, a situation that the operation goes to step S1-4 is illustrated.

The wireless frame editing dividing unit 9-4, shown in FIG. 1, makes at step S1-4 a wireless frame from the IP packet, or namely produces a frame shown in FIG. 2. At step S1-5, this wireless frame is stored in the data storing region 8-2, shown in FIG. 1, of the subsidiary memory 8 again.

The wireless frame transmitting receiving unit 9-5 sets up a connection to the transmission network through the wireless network 13 upon controlling the wireless I/F 5, shown in FIG. 1, at step S1-6.

The wireless frame transmitting receiving unit 9-5 shown in FIG. 1 reads the wireless frames out of the data storing region 8-2 in the subsidiary memory 8 shown in FIG. 1 and transmits the frames sequentially to the forwarding locations at step S1-7.

At step S1-8, the wireless frame transmitting receiving unit 9-5 shown in FIG. 1 executes disconnecting operation after transmitting the entire wireless frames and completes the flow. It is to be noted that a verification processing, if needed, may be inserted between step S1-6 and step S1-7.

Described here is a situation that the operation goes to step S1-9 from step S1-3. At step S1-9, the wired frame editing dividing unit 9-6 shown in FIG. 1 produces a wired frame from the IP packet. That is, the unit constitutes a frame as shown in portion (b) in FIG. 2 according to the Ethernet. At step S1-10, the wired frame is stored in the data storing region 8-2 shown in FIG. 1 of the subsidiary memory 8 shown in FIG. 1 again.

The wired frame transmitting receiving unit 9-7 (see, FIG. 1) sets up at step S1-11 a connection to the networks, to which data are transmitted, through the wired network 12 (see, FIG. 1) upon controlling the LAN I/F 4 (see, FIG. 1).

At step S1-12, the wired frame transmitting receiving unit 9-7 shown in FIG. 1 reads the wired frames out of the data storing region 8-2 in the subsidiary memory 8 shown in FIG. 1 and transmits the frames sequentially to the forwarding locations.

At step S1-13, the wired frame transmitting receiving unit 9-5 shown in FIG. 1 executes disconnecting operation after transmitting the entire wired frames and completes the flow. It is to be noted that a verification processing, if needed, may be inserted between step S1-11 and step S1-12.

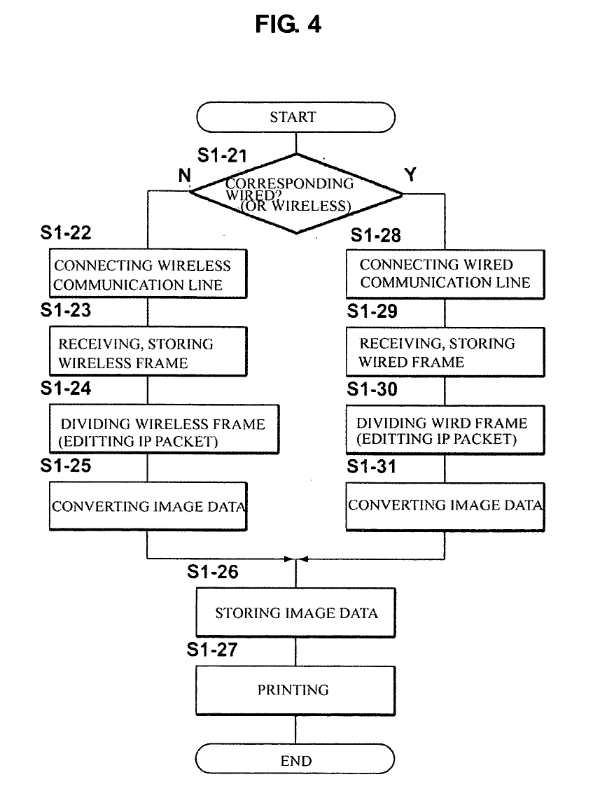

FIG. 4 is a flowchart for receiving operation of the first embodiment. This figure shows an example of receiving operation of the image processing apparatus in the first embodiment. Receiving operation of the image processing apparatus according to the first embodiment is described sequentially from step S1-21 to step S1-27.

At step S1-21, the wired and wireless distinguishing unit 9-3 (see, FIG. 1) distinguishes as to whether it is a connection request through the wired communication or a connection request through the wireless communication, from the received frame, or e.g., from the line connection request frame. This distinction is executed based on the header information added normally to the line connection request frame. If the resulted distinction is the connection request through the wireless communication, the operation goes to step S1-22, while if the resulted distinction is the connection request through the wired communication, the operation goes to step S1-28. First, described herein is a situation that the operation goes to step S1-22.

The wireless frame transmitting receiving unit 9-1 (see, FIG. 1) sets up a line connection with the network, to which the data are transmitted, through the wireless network 13 by controlling the wireless I/F 5 (see, FIG. 1) at step S1-22.

The wireless frame transmitting receiving unit 9-1 (see, FIG. 1) receives the wireless frame and stores the frame in the data storing region 8-2 (see, FIG. 1) in the subsidiary memory 8 (see, FIG. 1) at step S1-23.

At step S1-24, the wireless frame editing dividing unit 94 (see, FIG. 1) divides the wireless frame to compose the IP packet.

The image processing unit 9-1 (see, FIG. 1) converts the IP packet into image data according to a protocol matching to the network to which the data are transmitted and further converts the image data into printing data at step S1-25.

At step S1-26, the printing data are stored in the data storing region 8-2 (see, FIG. 1) in the subsidiary memory 8 (see, FIG. 1).

The printing data are sent to the printer engine 1 via the engine I/F 2 as controlled by the controller 9 at step S1-27, and the operation reaches the end of flow.

Next, a situation that the operation proceeds from step S1-21 to S1-28. At step S1-28, the wired frame transmitting receiving unit 9-7 (see, FIG. 1) sets up a line connection with the network, to which the data are transmitted, through the wired network 12 by controlling the LAN I/F 4 (see, FIG. 1).

The wired frame transmitting receiving unit 9-7 (see, FIG. 1) receives the wired frame and stores the frame in the data storing region 8-2 (see, FIG. 1) in the subsidiary memory 8 (see, FIG. 1) at step S1-29.

At step S1-30, the wired frame editing dividing unit 9-6 (see, FIG. 1) divides the wired frame to compose the IP packet.

The image processing unit 9-1 (see, FIG. 1) converts the IP packet into image data according to a protocol matching to the network to which the data are transmitted and further converts the image data into printing data at step S1-31. Subsequently, the operation goes through steps S1-26, S1-27, as described above, and reaches the end of flow.

According to this embodiment, as described above, the invented image processing apparatus can enjoy advantages that the apparatus can easily connect to prescribed networks as well as directly to other terminal devices either through the wired communication or through the wireless communication without using any wireless adaptor or the like. With this image processing apparatus according to this invention, programs to be changed or added can be reduced at the minimum level, because the wired frame editing dividing unit and the wireless frame editing dividing unit are formed with smaller size programs as separated from the programs commonly used for the wired and wireless communications having a relatively larger size containing programs relating to IP packet editions and divisions. The wired frame transmitting receiving unit and the wireless frame transmitting receiving unit are formed by the CPU's execution of the prescribed programs in the image processing apparatus, so that changes in the communication standards matching to the apparatus can be advantageously done through the networks.

Although in this embodiment the header for wireless communication is judged to distinguish as to whether the frame is for the wireless LAN network or the wired LAN network, substantially the same procedure is applicable, by distinguishing headers of respective frames, to a situation that two wired networks having different communication protocols are used.

### Second Embodiment

In this embodiment, the invented image processing apparatus is aiming to be connectable to various wireless networks having different MAC (media access controller) layers, features of base band, carrier frequencies, etc.

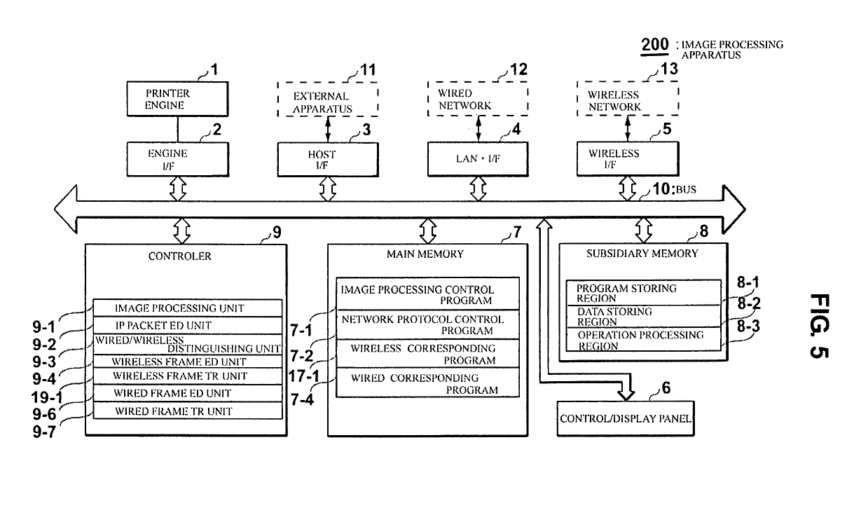

FIG. 5 is a structural block diagram showing the image processing apparatus according to the second embodiment. As shown in FIG. 5, the image processing apparatus 200 in the second embodiment includes a printer engine 1, an engine I/F 2, a host I/F 3, a LAN I/F 4, a wireless I/F 5, a control and display panel 6, a main memory 17, a subsidiary memory 8, a controller 19, and a bus 10. Described below are only portions different from those in the first embodiment, and substantially the same portions as those in the first embodiment are assigned with the same reference numbers as in the first embodiment.

The main memory 17 is a memory previously storing control programs and control data necessary for controlling the image processing apparatus 200 by the controller 19. In this embodiment, stored in the main memory 17 in advance are particularly, an image processing control program 7-1, a network protocol control program 7-2, a wireless corresponding program 17-1, and a wired corresponding program 17-2.

The wireless corresponding program 17-1 is a program executing a processing to be added partly to the network protocol control program 7-2 in a case where the image processing apparatus 200 is connected to a prescribed network through the wireless communication, as in substantially the same manner as in the first embodiment. Furthermore, a program to partly change the setting about functions according to setting change requests from the operator is added in this embodiment.

The controller 19 is a CPU for controlling the image processing apparatus 200, and in this embodiment is particularly made of an image processing unit 9-1, an IP packet editing dividing unit 9-2, a wired and wireless distinguishing unit 9-3, a wireless frame editing dividing unit 9-4, a wireless frame transmitting receiving unit 19-1, a wired frame editing dividing unit 9-6, and a wired frame transmitting receiving unit 9-7, which are composed by execution of some control programs temporarily stored in the subsidiary memory 8.

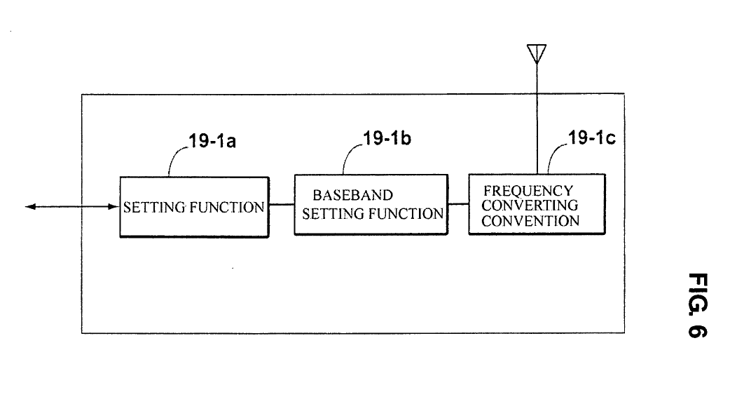

The wireless frame transmitting receiving unit 19-1 is a controlling means for transmitting and receiving frames through the wireless I/F 5. In this embodiment, a function to partly alter the setting of functions according to the change request by the operator is added. The detail is described in reference to FIG. 6.

FIG. 6 is an illustration of the wireless frame transmitting receiving unit in the second embodiment. As shown in FIG. 6, the wireless frame transmitting receiving unit in the second embodiment includes functions of a MAC setting function 19-1a, a base band setting function 19-1b, and a frequency converting function 19-1c. The MAC setting function 19-1a is a function for setting a method for transmitting and receiving frames, a frame format, an error detecting method, etc. The base band setting function 19-1b is a function for setting, e.g., a method for modifying the frames, communication mode such as the ad hoc mode, infrastructure mode, etc. The frequency converting function 19-1c is a function for setting a carrier frequency for wireless communications. Other structural portions and these operations are substantially the same as those in the first embodiment, and for the sake of simplicity, those duplicated descriptions are omitted.

As described above, in this embodiment, because the apparatus has the functions of the MAC setting function 19-1a, the base band setting function 19-1b, and the frequency converting function 19-1c, the apparatus has an advantage that the invented apparatus can connect to various wireless networks even having different MAC layers, base band features, and carrier frequencies. The image processing apparatus according to this invention can advantageously set and change functions such as the MAC setting function 19-1a, the base band setting function 19-1b, and the frequency converting function 19-1c, through the networks, because the CPU incorporated in the image processing apparatus controls the setting without using any NIC or wireless LAN module.

### Third Embodiment

In this embodiment, the image processing apparatus is aiming to be easily adaptable to a nation-based standard or protocol at the nation to which this apparatus is delivered or provided, in assuming a situation that the image processing apparatus is delivered to plural nations having different standards or protocols or a situation that the image processing apparatus according to the invention in use in a prescribed nation currently is brought to a network in another nation having a different standard or protocol.

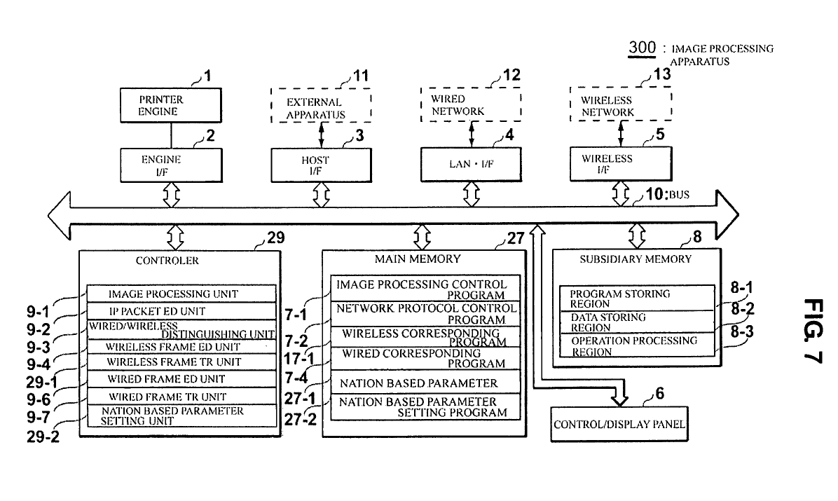

FIG. 7 is a structural block diagram showing an image processing apparatus in the third embodiment. As shown in FIG. 7, the image processing apparatus 300 of the third embodiment includes a printer engine 1, an engine I/F 2, a host I/F 3, a LAN I/F 4, a wireless I/F 5, a control and display panel 6, a main memory 27, a subsidiary memory 8, a controller 29, and a bus 10. Described below are only portions different from those in the first embodiment, and substantially the same portions as those in the first embodiment are assigned with the same reference numbers as in the first embodiment.

The main memory 27 is a memory previously storing control programs and control data necessary for controlling the image processing apparatus 300 by the controller 29. In this embodiment, stored in the main memory 27 in advance are particularly, an image processing control program 7-1, a network protocol control program 7-2, a wireless corresponding program 17-1, a wired corresponding program 7-4, a nation based parameter 27-1, and a nation based parameter setting program 27-2.

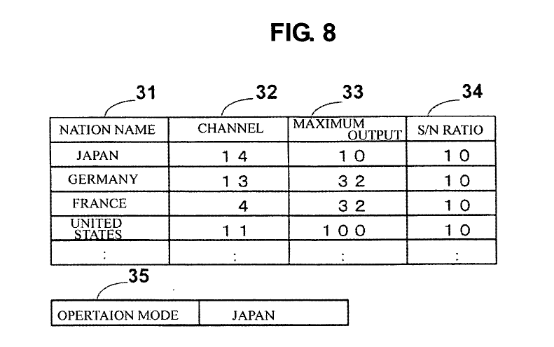

The nation based parameter 27-1 is a table gathering wireless standards or protocols of respective nations. FIG. 8 is an illustration for the nation based parameter in the third embodiment. As shown in FIG. 8, the nation based parameter in the third embodiment, as an example, is a table containing information such as, e.g., nation name 31, channel 32, maximum output 33, and S/N ratio 34. Where the operator selects a prescribed nation at an operation mode 35 using the control and display panel 6, the various features of the nation are selected. As shown in FIG. 8, if “Japan” is selected as an example, the channel is set to fourteen (14); the maximum output is set to 10 mW; the S/N ratio is set to 10 dB.

The nation based parameter setting program 27-2 is a program for adapting the image processing apparatus 300 to the standard or protocol of the prescribed nation stored in the nation based parameter 27-1, by execution done by the controller 29.

The controller 29 is a CPU for controlling the image processing apparatus 300, and in this embodiment is particularly made of an image processing unit 9-1, an IP packet editing dividing unit 9-2, a wired and wireless distinguishing unit 9-3, a wireless frame editing dividing unit 9-4, a wireless frame transmitting receiving unit 29-1, a wired frame editing dividing unit 9-6, a wired frame transmitting receiving unit 9-7, and a nation based parameter setting unit 29-2, which are composed by execution of some control programs temporarily stored in the subsidiary memory 8.

The wireless frame transmitting receiving unit 29-1 is a controlling means for transmitting and receiving frames through the wireless I/F 5. In this embodiment, the setting of the wireless transmitting receiving standards or protocols can be changed according to the standard or protocol based on the respective nations defined in the nation based parameter 27-1 in association with the nation based parameter setting unit 29-2.

The nation based parameter setting unit 29-2 is a means for changing the wireless transmitting receiving standard or protocol possessed at the wireless I/F 5 based on the nation based standard or protocol defined at the nation based parameter 27-1 according to a change request from the operator. Other structural portions and these operations are substantially the same as those in the first embodiment, and for the sake of simplicity, those duplicated descriptions are omitted.

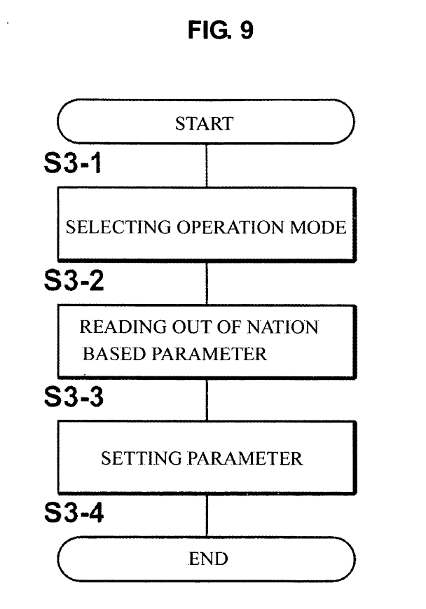

Next, operation of the nation based parameter setting unit 29-2, which is newly added in this embodiment, is described. FIG. 9 is an operation flowchart of the nation based parameter setting unit. FIG. 9 illustrates wireless standard setting operation for render the apparatus adaptable to the wireless transmitting receiving standard set at the respective nations in a case where the image processing apparatus 300 is delivered to plural nations having different standards or where the image processing apparatus 300 currently in use in a prescribed nation is brought to a network in another nation having a different standard. It is to be noted that the image processing apparatus 300 according to this embodiment already stores the nation based parameter 27-1 (see, FIG. 7) and the nation based parameter setting program 27-2 (see, FIG. 7) in the main memory 27 (see, FIG. 7) at a time shipping from the factory. This flow is described in the order of steps from step S3-1 to S3-4.

At step S3-1, the operator enters a prescribed nation name into the operation mode 35 using the control and display panel 6 (see, FIG. 7). For example, the nation “Japan” is entered.

The nation based parameter setting unit 29-2 at step S3-2 reads the entered parameter (i.e., standard) of the nation name out of the nation based parameter 27-1. Herein, selected is the Japanese parameter: the channel of fourteen (14), the maximum output 10 mW, and the S/N ratio of 10 dB.

The nation based parameter setting unit 29-2 (see, FIG. 7) at step S3-3 changes the wired transmitting receiving standard of the wired I/F 5 (see, FIG. 7) to be the Japanese parameter, i.e., the channel of fourteen (14), the maximum output 10 mW, and the S/N ratio of 10 dB, and completes the flow. The subsequent steps are substantially the same as those described in the first embodiment in reference to FIG. 3 and FIG. 4, and for the sake of simplicity, those duplicated descriptions are omitted.

It is to be noted that in the above description, the main memory 27 (see, FIG. 7) stores the nation based parameter 27-1 (see, FIG. 7) and the nation based parameter setting program 27-2 (see, FIG. 7) at a time shipping the factory, but this invention is not limited to those. That is, the operator may enter respectively operation standards of the wireless transmitting receiving standards (see, FIG. 7) of the wireless I/F 5 (see, FIG. 7) when necessary, using the control and display panel 6.

As described above, according to this embodiment, the image processing apparatus 300 can enjoy advantages that the apparatus can easily adapt the nation's standard or protocol in the nation to which this apparatus is delivered or provided, in a case where the image processing apparatus is delivered to plural nations having different standards or protocols or where the image processing apparatus 300 according to the invention currently in use in a prescribed nation is brought to a network in another nation having a different standard or protocol. The image processing apparatus 300 further takes advantages that the above standard or protocol can be set and changed through the network, because controlled by the CPU mounted inside the apparatus without using any NIC or wireless LAN module.

### Fourth Embodiment

In this embodiment, it is assumed that common standards for area constituted of plural nations exist in the above third embodiment, and the image processing apparatus is aiming to be easily adaptable to the standard common in an area as well as the standard based on the nations.

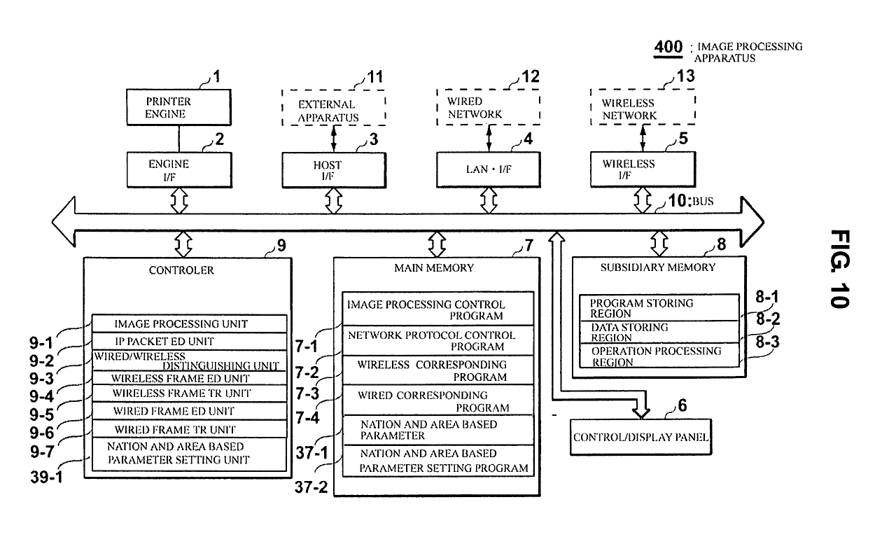

FIG. 10 is a structural block diagram showing an image processing apparatus in the fourth embodiment. As shown in FIG. 10, the image processing apparatus 400 of the fourth embodiment includes a printer engine 1, an engine I/F 2, a host I/F 3, a LAN I/F 4, a wireless I/F 5, a control and display panel 6, a main memory 37, a subsidiary memory 8, a controller 39, and a bus 10. Described below are only portions different from those in the third embodiment, and substantially the same portions as those in the third embodiment are assigned with the same reference numbers as in the third embodiment.

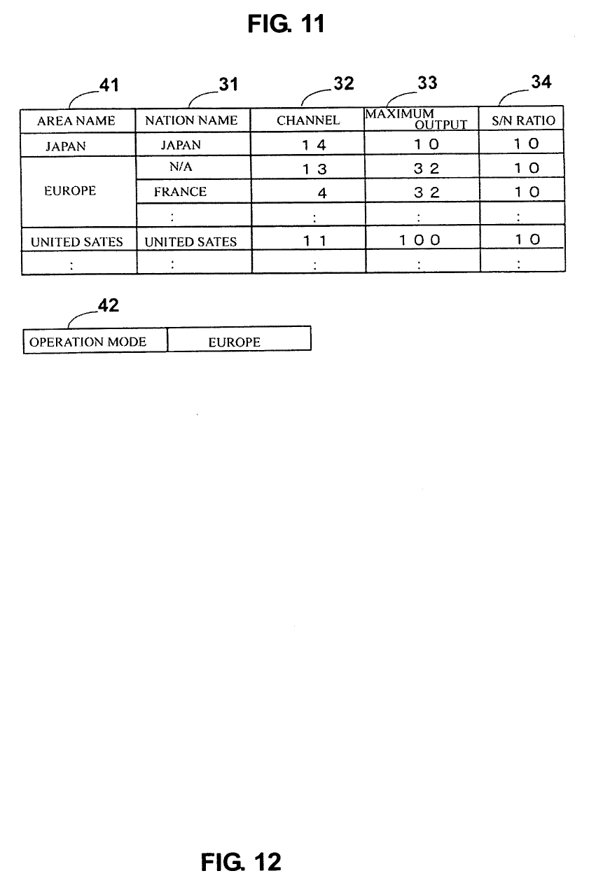

The main memory 37 is a memory previously storing control programs and control data necessary for controlling the image processing apparatus 400 by the controller 39. In this embodiment, stored in the main memory 37 in advance are particularly, an image processing control program 7-1, a network protocol control program 7-2, a wireless corresponding program 17-1, a wired corresponding program 7-4, a nation and area based parameter 37-1, and a nation and area based parameter setting program 37-2. The nation based parameter 37-1 is a table gathering wireless standards or protocols of respective nations. FIG. 11 is an illustration for the nation and area based parameter. As shown in FIG. 11, the nation and area based parameter in the fourth embodiment, as an example, is a table containing information such as, e.g., nation name 31, channel 32, maximum output 33, S/N ratio 34, and area name 41. Where the operator selects a prescribed nation or area at an operation mode 42 using the control and display panel 6 (see, FIG. 10), the various features of the nation or area are selected. As shown in FIG. 11, if “Europe” is selected as an example, the channel, the maximum output, and the S/N ratio are set to thirteen (13), 32 mW, and 10 dB, respectively, under the standard, not shown, adapted over the plural nations in Europe.

The nation and area based parameter setting program 37-2 is a program for adapting the image processing apparatus 400 to the standard or protocol of the prescribed nation or to the standard or protocol used over plural nations in a prescribed area stored in the nation and area based parameter 37-1, by execution done by the controller 39.

The controller 39 is a CPU for controlling the image processing apparatus 400, and in this embodiment is particularly made of an image processing unit 9-1, an IP packet editing dividing unit 9-2, a wired and wireless distinguishing unit 9-3, a wireless frame editing dividing unit 94, a wireless frame transmitting receiving unit 29-1, a wired frame editing dividing unit 9-6, a wired frame transmitting receiving unit 9-7, and a nation and area based parameter setting unit 39-1, which are composed by execution of some control programs temporarily stored in the subsidiary memory 8.

The nation and area based parameter setting unit 39-1 is a means for changing the wireless transmitting receiving standard or protocol possessed at the wireless I/F 5, based on the nation based standard or protocol or a standard or protocol used over plural nations in a prescribed area defined at the nation and area based parameter 37-1, according to a change request from the operator. Other structural portions and these operations are substantially the same as those in the third embodiment, and for the sake of simplicity, those duplicated descriptions are omitted.

Next, operation of the nation and area based parameter setting unit 39-1, which is newly added in this embodiment, is described. FIG. 12 is an operation flowchart of the nation and area based parameter setting unit. FIG. 9 illustrates wireless standard setting operation for render the apparatus adaptable to the wireless transmitting receiving standard set at the respective nations in a case where the image processing apparatus 400 is delivered to plural nations or areas having different standards or where the image processing apparatus currently in use in a prescribed nation is brought to a network in another nation or an area astride plural nations having a different standard. It is to be noted that the image processing apparatus 400 according to this embodiment already stores the nation and area based parameter 37-1 (see, FIG. 10) and the nation and area based parameter setting program 37-2 (see, FIG. 10) in the main memory 37 (see, FIG. 30) at a time shipping from the factory. This flow is described in the order of steps from step S4-1 to S4-5.

At step S4-1, the operator enters a prescribed nation name or area name into the operation mode 42 using the control and display panel 6 (see, FIG. 10). For example, the area “Europe” is entered.

The nation and area based parameter setting unit 39-1 at step S4-2 proceeds the operation to step S4-3 if the information entered from the nation and area based parameter 37-1 is a nation name and to step S4-4 if that is an area name.

The nation and area based parameter setting unit 39-1 at step S4-3 reads the entered parameter (i.e., standard) of the nation name out of the nation and area based parameter 37-1. The nation and area based parameter setting unit 39-1 at step S4-3 reads the entered parameter (i.e., standard) of the area name with no nation name out of the nation and area based parameter 37-1. Herein, read out is the European parameter with no nation name: the channel of thirteen (13), the maximum output 32 mW, and the S/N ratio of 10 dB.

At step S4-5, the nation and area based parameter setting unit 39-1 (see, FIG. 10) sets or changes the wired transmitting receiving standard of the wired I/F 5 (see, FIG. 10) to be the entered nation name or area name parameter, i.e., standard or protocol, and herein, the parameter of Europe with no nation name having the channel of thirteen (13), the maximum output 32 mW, and the S/N ratio of 10 dB, and completes the flow. The subsequent steps are substantially the same as those described in the first embodiment in reference to FIG. 3 and FIG. 4, and for the sake of simplicity, those duplicated descriptions are omitted.

It is to be noted that in the above description, the main memory 37 (see, FIG. 10) stores the nation and area based parameter 37-1 (see, FIG. 10) and the nation and area based parameter setting program 37-2 (see, FIG. 10) at a time shipping the factory, but this invention is not limited to those. That is, the operator may enter respectively operation standards of the wireless frame transmitting receiving unit 29-1 (see, FIG. 10) when necessary, using the control and display panel 6 (see, FIG. 10).

As described above, according to this embodiment, the image processing apparatus 400 can enjoy advantages that the apparatus can easily adapt the nation's standard or protocol or a standard or protocol used over plural nations in the area in the nation or in the area to which this apparatus is delivered or provided, in a case where the image processing apparatus is delivered to plural nations or a prescribed area having different standards or protocols or where the image processing apparatus 400 according to the invention currently in use in a prescribed nation is brought to a network in another nation or a prescribed area having a different standard or protocol.

### Fifth Embodiment

In this embodiment, in assuming, in the first to fourth embodiments, that particular information such as, e.g., passwords, encryption processing methods, and the like is used in the image processing apparatus, or that particular information already used is to be altered, the apparatus is aiming that such particular information is easily set or changed.

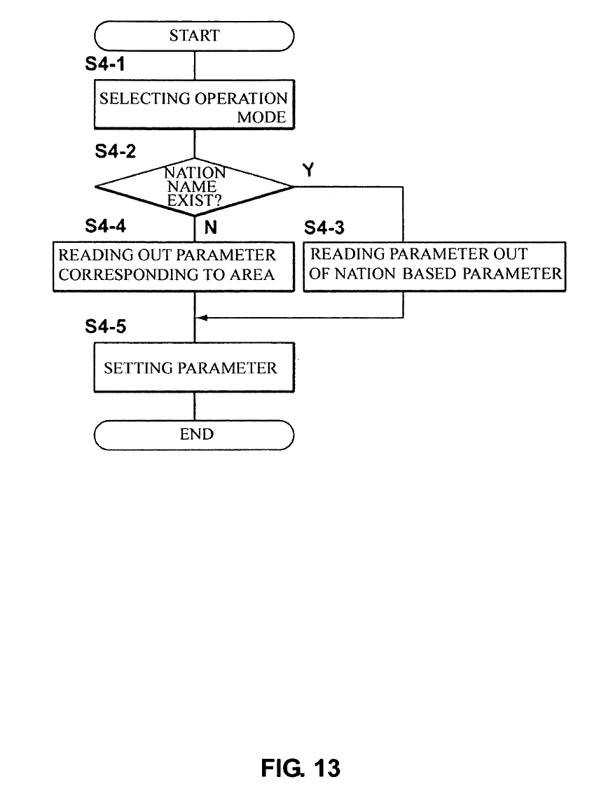

FIG. 13 is a structural block diagram showing an image processing apparatus in the fifth embodiment. As shown in FIG. 13, the image processing apparatus 500 of the fifth embodiment includes a printer engine 1, an engine I/F 2, a host I/F 3, a LAN I/F 4, a wireless I/F 5, a control and display panel 6, a main memory 47, a subsidiary memory 8, a controller 49, and a bus 10. Described below are only portions different from those in the first embodiment, and substantially the same portions as those in the first embodiment are assigned with the same reference numbers as in the first embodiment.

The main memory 47 is a memory previously storing control programs and control data necessary for controlling the image processing apparatus 500 by the controller 49. In this embodiment, stored in the main memory 47 in advance are particularly, an image processing control program 7-1, a network protocol control program 7-2, a wireless corresponding program 7-3, a wired corresponding program 74, particular information 47-1, and a particular information corresponding program 47-2.

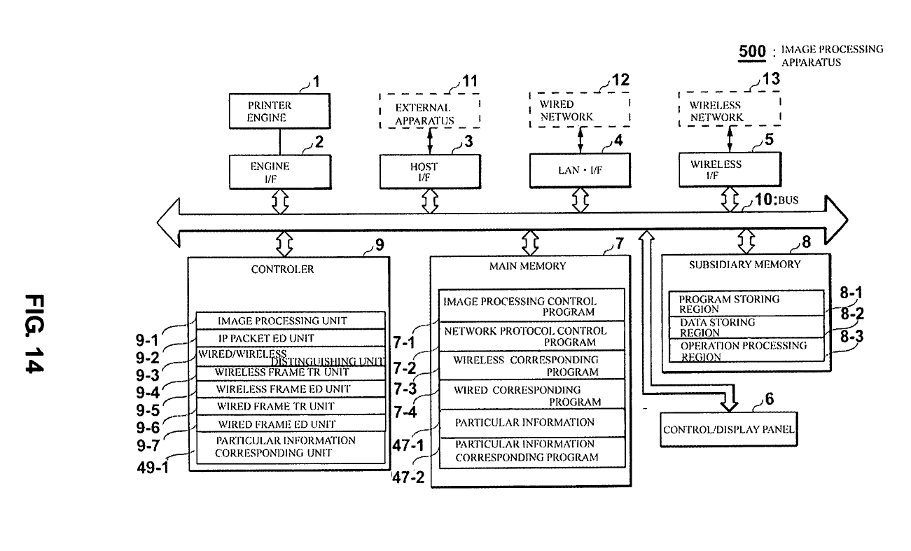

The particular information 47-1 is a table gathering particular information special for the image processing apparatus 500 as an example, and is information previously stored in use of the control and display panel 6 by the operator. FIG. 14 is a diagram showing the particular information. As shown in FIG. 14, the table gathering the particular information includes an item 51 and contents 52. For example, such as Wireless ID as an SSID (password) and 012345abc as WEP1 (encryption method) are stored in advance by the operator.

The particular information corresponding program 47-2 is a program composing a means (example) for specifying the frames transmitted and received by the wireless frame transmitting receiving unit 29-1 and for encrypting and decrypting the frames, by execution of the controller 39, and is a program previously stored by the operator using the control and display panel 6 (see, FIG. 13).

The controller 49 is a CPU for controlling the image processing apparatus 500, and in this embodiment is particularly made of an image processing unit 9-1, an IP packet editing dividing unit 9-2, a wired and wireless distinguishing unit 9-3, a wireless frame editing dividing unit 9-4, a wireless frame transmitting receiving unit 9-5, a wired frame editing dividing unit 9-6, a wired frame transmitting receiving unit 9-7, and a particular information corresponding unit 49-1, which are composed by execution of some control programs temporarily stored in the subsidiary memory 8.

The particular information corresponding unit 49-1 is a means for specifying the frames transmitted and received by the wireless frame transmitting receiving unit 29-1 and further for encrypting and decrypting the frames, by execution of the particular information corresponding program 47 using the particular information 47-1. Other portions are substantially the same as those in the first embodiment, and for the sake of simplicity, those duplicated descriptions are omitted.

As described above, in this embodiment, the image processing apparatus can surely maintain secret matters of communicated contents by having the particular information corresponding unit 49-1, and can easily set and change the particular information because the operator can store the particular information 47-1 and the particular information corresponding program using the control and display panel 6 (see, FIG. 13). With the image processing apparatus according to the invention is advantageous for setting and changing the standards or protocols through the networks because controlled by the CPU incorporated inside the image processing apparatus without using any NIC or wireless LAN module.

### Sixth Embodiment

In this embodiment, the image processing apparatus with a structure described in any one of the first to fifth embodiments is aiming that address information specifying the address owned by the apparatus such as, e.g., IP address, Sub-net mask, and default gateway, in the networks is easily changed.

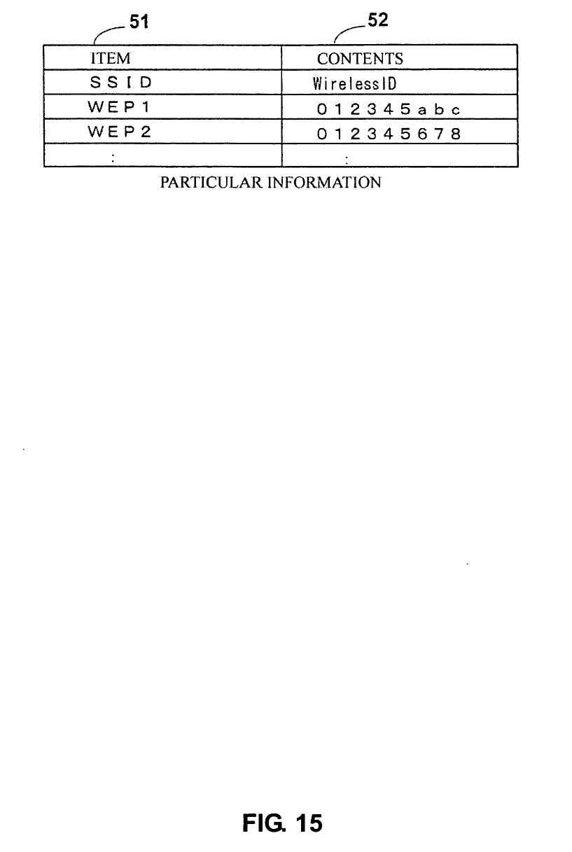

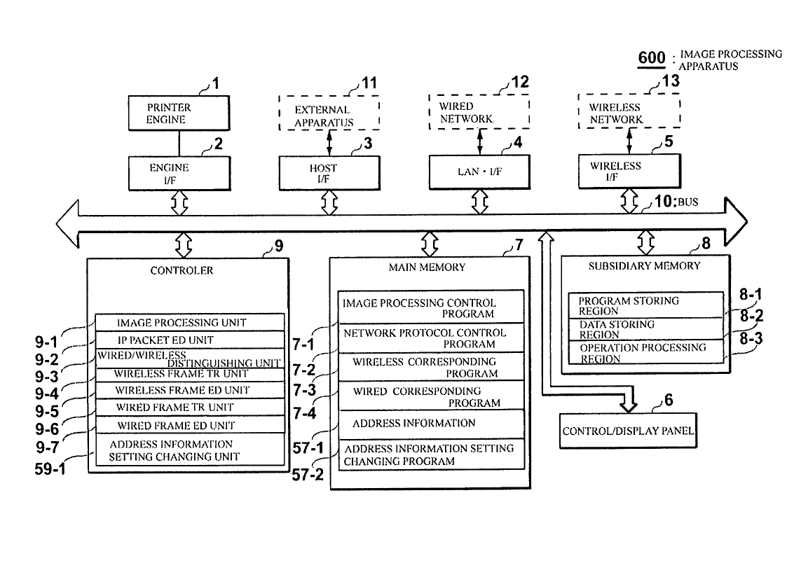

FIG. 15 is a structural block diagram showing an image processing apparatus in the sixth embodiment. As shown in FIG. 15, the image processing apparatus 600 of the sixth embodiment includes a printer engine 1, an engine I/F 2, a host I/F 3, a LAN I/F 4, a wireless I/F 5, a control and display panel 6, a main memory 57, a subsidiary memory 8, a controller 59, and a bus 10.

The main memory 57 is a memory previously storing control programs and control data necessary for controlling the image processing apparatus 600 by the controller 59. In this embodiment, stored in the main memory 57 in advance are particularly, an image processing control program 7-1, a network protocol control program 7-2, a wireless corresponding program 7-3, a wired corresponding program 7-4, address information 57-1, and an address information setting changing program 57-2.

The address information 57-1 is a table (example) gathering address information relating to the apparatus itself in the network to which the image processing apparatus 600 is provided, and is information stored in advance by the operator using the control and display panel 6.

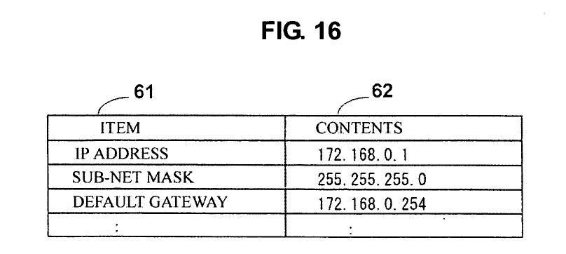

FIG. 16 is a diagram showing the address information. As shown in FIG. 16, the table (example) gathering the address information contains item 61 and contents 62. For example, numbers such as “172.168.0.1” as IP address and “255.255.255.0” as sub-net mask, are stored though the networks by the network manager or the like in advance. The address information setting changing program 57-2 is a program for setting and changing the self address by execution of the controller 59.

An address information setting changing unit 59-1 is a means for specifying the frames transmitted and received by the wireless frame transmitting receiving unit 29-1 by executing the address information setting changing program 57-2 when accepting the address information entered by the network manager or the like through the network. Other portions are substantially the same as those in the first embodiment, and for the sake of simplicity, those duplicated descriptions are omitted.

As described above, in this embodiment, the image processing apparatus can easily set and change the network common information (such as, e.g., the address information) with another terminal apparatus in the network through the wired or wireless communication by having the address information setting changing unit 59-1. The image processing apparatus according to the invention is advantageous for setting and changing the standards or protocols through the networks because controlled by the CPU incorporated inside the image processing apparatus without using any NIC or wireless LAN module.

In the above description, some units and means structuring the invention are composed by execution of the prescribed programs in the CPU, but this invention is not limited to this. That is, all or a part of the units and means may be formed of special electronic circuits or cards. In addition, this invention is applicable not only to printers but also to scanners or other devices.

With the image processing apparatus according to the invention, the apparatus is advantageously connectable to a prescribed network as well as directly to other terminal apparatuses easily through any of wired and wireless communications without using any adaptor device for wireless communication. The image processing apparatus according to the invention composes the wired frame editing dividing unit and the wireless frame editing dividing unit, which are relatively small in size, as separated from the programs having a large size used commonly for the wired and wireless communications (including the programs relating to IP packet edition and division), so that the program to be altered or added can be advantageously suppressed to be the minimum size in this invention. Furthermore, because the wired frame transmitting receiving unit and the wireless frame transmitting receiving unit are composed by executing the prescribed programs at the CPU in the image processing apparatus, the transmitting receiving standards matching to the apparatus can be changed through the network.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

What is claimed is:

1. An image processing apparatus connecting to a prescribed network through wired or wireless communications and receiving a frame from another terminal apparatus connecting to the network, said image processing apparatus comprising:
a wired and wireless distinguishing unit for distinguishing as to whether said frame is received through the wired communication or through the wireless communication;
a wired communication frame dividing unit for dividing said frame on a basis of a wired communication corresponding protocol in a case where said frame is received through the wired communication according to the distinguished result obtained at said wired and wireless distinguishing unit; and
a wireless communication frame dividing unit for dividing said frame on a basis of a wireless communication corresponding protocol in a case where said frame is received through the wireless communication according to the distinguished result obtained at said wired and wireless distinguishing unit.

2. The image processing apparatus according to claim 1, further comprising a wired communication frame transmitting and receiving unit for transmitting and receiving said frame through the wired communication, and a wireless communication frame transmitting and receiving unit for transmitting and receiving said frame through the wireless communication.

3. The image processing apparatus according to claim 2, wherein said wireless communication frame transmitting and receiving unit has a function to change through the network a wireless transmitting and receiving standard matching to itself.

4. The image processing apparatus according to claim 2, wherein said wireless communication frame transmitting and receiving unit has a function to change through the network a nation based wireless transmitting and receiving standard matching to itself.

5. The image processing apparatus according to claim 4, wherein said national wireless transmitting and receiving standard includes an area based wireless transmitting and receiving standard in which the area includes a plurality of nations.

6. The image processing apparatus according to claim 2, wherein said wireless communication frame transmitting and receiving unit has a function to change a self particular information through the network.

7. The image processing apparatus according to claim 2, wherein said wireless communication frame transmitting and receiving unit has a function to change a self address information through the network.

8. An image processing apparatus connecting to a prescribed network through wired or wireless communications and transmitting prescribed information to another terminal apparatus connecting to the network, said image processing apparatus comprising:
a wired and wireless distinguishing unit for distinguishing as to whether said prescribed information is to be transmitted through the wired communication or through the wireless communication;
a wired communication frame editing unit for editing said prescribed information to a wired communication frame on a basis of a wired communication protocol; and
a wireless communication frame editing unit for editing said prescribed information to a wireless communication frame on a basis of a wireless communication protocol,
wherein said prescribed information is edited with either said wired communication frame editing unit or said wireless communication frame editing unit according to a distinguishing result obtained from said wired and wireless distinguishing unit.

9. The image processing apparatus according to claim 8, further comprising a wired communication frame transmitting and receiving unit for transmitting and receiving said prescribed information through the wired communication, and a wireless communication frame transmitting and receiving unit for transmitting and receiving said prescribed information through the wireless communication.

10. The image processing apparatus according to claim 9, wherein said wireless communication frame transmitting and receiving unit has a function to change through the network a wireless transmitting and receiving standard matching to itself.

11. The image processing apparatus according to claim 9, wherein said wireless communication frame transmitting and receiving unit has a function to change through the network a nation based wireless transmitting and receiving standard matching to itself.

12. The image processing apparatus according to claim 11, wherein said national wireless transmitting and receiving standard includes an area based wireless transmitting and receiving standard in which the area includes a plurality of nations.

13. The image processing apparatus according to claim 9, wherein said wireless communication frame transmitting and receiving unit has a function to change a self particular information through the network.

14. The image processing apparatus according to claim 9, wherein said wireless communication frame transmitting and receiving unit has a function to change a self address information through the network.

15. An image processing apparatus connected to a first network and a second network categorically different from said first network, receiving a frame including prescribed information through said first and second networks, said image processing apparatus comprising:
a frame distinguishing unit for distinguishing as to whether said frame is received through said first network or through said second network;
a first frame dividing unit for retrieving said prescribed information upon dividing said frame of said first network; and
a second frame dividing unit for retrieving said prescribed information upon dividing said frame of said second network,
wherein said prescribed information is obtained upon dividing said frame received through either said first frame dividing unit or said second frame dividing unit according to a distinguishing result obtained at said frame distinguishing unit.

16. The image processing apparatus according to claim 15, wherein said prescribed information is prescribed packet information.

17. The image processing apparatus according to claim 16, wherein said prescribed packet information includes an IP packet.
